(19) United States
(12) Patent Application Publication
(10) Pub. No.: US 2023/0325963 A1
(43) Pub. Date: Oct. 12, 2023

(54) IMAGE PROCESSING METHOD AND APPARATUS FOR MOBILE TERMINAL, AND STORAGE MEDIUM AND TERMINAL

(71) Applicant: SPREADTRUM COMMUNICATIONS (TIANJIN) CO., LTD., Tianjin (CN)

(72) Inventor: Xiaowei LIU, Pudong New Area Shanghai (CN)

(21) Appl. No.: 18/023,223

(22) PCT Filed: Aug. 25, 2021
(86) PCT No.: PCT/CN2021/114485

§ 371 Date: Feb. 24, 2023

(30) Foreign Application Priority Data
Aug. 26, 2020 (CN) 202010873807.1

(51) Int. Cl. G06T 1/20; G06F 9/48; G06T 7/11; H04M 1/725

(52) U.S. Cl. CPC G06T 1/20; G06F 9/4881; G06T 7/11; H04M 1/725

(57) ABSTRACT

An image processing method and apparatus for a mobile terminal, and a storage medium and a terminal. The method comprises: receiving an image photographed by a mobile terminal, and generating a first image processing task for the image; determining a first division granularity according to the minimum data processing unit of a plurality of first processing platforms, and dividing the first image processing task into a plurality of sub-tasks according to the first division granularity; allocating the plurality of sub-tasks to the plurality of first processing platforms; and receiving processing results fed back by all the first processing platforms and fusing same together to obtain an image processing result.

### CROSS REFERENCE TO RELATED APPLICATIONS

This is the U.S. national stage of application No. PCT/CN2021/114485, filed on Aug. 25, 2021. Priority under 35 U.S.C. §119(a) and 35 U.S.C. §365(b) is claimed from Chinese Application No. 202010873807.1, filed Aug. 26, 2020, the disclosure of which is also incorporated herein by reference.

### FIELD

The present disclosure relates to the technical field of image algorithm processing, and in particular to a method and apparatus for processing image for a mobile terminal, a storage medium, and a terminal.

### BACKGROUND

With the rapid development of mobile terminal market and image technology, people are increasingly demanding for photographing function of mobile terminals. However, a better photographing effect is associated with higher algorithm complexity and longer processing time. Therefore, algorithm performance becomes the bottleneck of algorithm production. Terminal manufacturers or chip manufacturers provide software or hardware solutions to accelerate algorithm processing according to features of their products. However, under limited conditions or resources, a single algorithm acceleration scheme may still be unable to meet performance requirements of mobile terminals for image processing.

Usually, a single one algorithm acceleration scheme is applied for image processing in mobile terminals. Although the algorithm can be accelerated by several times or dozens of times, a growing demand for image processing speed cannot be met. In particular, some advanced and complex image processing algorithms require long processing time, resulting in bad experience of terminal products or even failure in application on low-end products.

### SUMMARY

In view of this, a method for processing image for a mobile terminal is provided according to the embodiments of the present disclosure. The method for processing image includes:
receiving an image photographed by the mobile terminal, and generating a first image processing task for the image;
determining a first division granularity based on minimum data processing units of multiple first processing platforms, and dividing the first image processing task into multiple sub-tasks according to the first division granularity;
allocating the multiple sub-tasks to the multiple first processing platforms; and
receiving processing results fed back by the multiple first processing platforms and combining the processing results to obtain an image processing result.

An apparatus for processing image for a mobile terminal is further provided according to the embodiments of the present disclosure. The apparatus includes: a first receiving module configured to receive an image photographed by the mobile terminal, and generate a first image processing task for the image; a division module configured to determine a first division granularity based on minimum data processing units of a plurality of first processing platforms, and divide the first image processing task into a plurality of sub-tasks according to the first division granularity; an allocation module configured to allocate the plurality of sub-tasks to the plurality of first processing platforms; and a second receiving module configured to receive processing results fed back by the plurality of first processing platforms and obtain an image processing result by fusing the processing results.

A storage medium is further provided according to the embodiments of the present disclosure. The storage medium stores a computer program that, when being executed by a processor, implements the method described above.

A terminal device is further provided according to the embodiments of the present disclosure. The terminal device incudes a memory and a processor. The memory stores a computer program executable by the processor. The processor is configured to execute the computer program to implement the method described above.

### BRIEF DESCRIPTION OF THE DRAWINGS

FIG. 1 is a flowchart of a method for processing image for a mobile terminal according to an embodiment of the present disclosure.

FIG. 2 is a schematic structural diagram of an apparatus for processing image for a mobile terminal according to an embodiment of the present disclosure.

### DETAILED DESCRIPTION OF EMBODIMENTS

As stated in the background, under limited conditions or resources, a single algorithm acceleration scheme cannot meet performance requirements of mobile terminals for image processing.

Specifically, there are two types of algorithm acceleration schemes commonly applied to mobile terminals.

In the first type of algorithm acceleration scheme, algorithm processing acceleration is realized based on hardware Application Specific Integrated Circuit (ASIC), such as an Image Signal Processing (ISP) chip. The ISP chip is capable of performing image algorithm processing such as black level correction, automatic exposure, automatic white balance, and noise reduction on images outputted by image sensors.

However, the algorithm processing acceleration scheme implemented based on hardware does not have universality and scalability and is incapable for accelerating other algorithm processing.

In the second type of algorithm acceleration scheme, algorithm processing acceleration is realized based on software of general computing hardware. The general computing hardware includes, but not limited to, a Central Processing Unit (CPU), a Graphics Processing Unit (GPU), a Digital Signal Processing (DSP), and the like. The general computing hardware generally has a parallel acceleration function.

CPU multi-core and parallel instructions, for example, Multiple Threads ARM architecture processor extension architecture (Arm Neon) technology, may be used in algorithm processing acceleration. Neon registers may be regarded as a group of elements of a vector where the elements have the same data type. Neon instructions may be used for simultaneously operating multiple elements of the vector.

GPU may be used in algorithm processing acceleration. GPU has Single Instruction Multiple Threads (SIMT) architecture. Different from Single Instruction Multiple Data (SIMD), the SIMT has an advantage that a developer is not required to organize data into a vector with an appropriate length. In addition, in the SIMT, each thread is allowed to have different branches. Functions with a conditional jump cannot be executed in parallel by using SIMD only. Apparently, the conditional jump has different behavior in different threads according to different input data, which can only be achieved by using the SIMT.

DSP may be used in algorithm processing acceleration. For example, the algorithm processing acceleration may be performed by using processor architecture of a specific DSP platform, which has an advanced variable instruction length, super long instruction words and supports hardware multiple threads mechanism.

However, a mobile terminal usually uses only one of the above algorithm acceleration schemes in image processing, which cannot meet the growing demand. Some advanced and complex image processing algorithms are still time-consuming even if the above acceleration schemes are used. This time consuming problem results in poor experience of the mobile terminals and even failure in application on low-end products.

In order to solve the above technical problems, a method for processing image for a mobile terminal is provided according to the embodiments of the present disclosure. The method for processing image includes: receiving an image photographed by the mobile terminal, and generating a first image processing task for the image; determining a first division granularity based on minimum data processing units of multiple first processing platforms, and dividing the first image processing task into multiple sub-tasks according to the first division granularity; allocating the multiple sub-tasks to the multiple first processing platforms; and receiving processing results fed back by the multiple first processing platforms and obtaining an image processing result by fusing the processing results.

By means of the solution according to the embodiments, multi-hardware heterogeneous combined-acceleration can be realized by combining resources and algorithm acceleration schemes of the mobile terminal to further reduce time consumption of algorithm processing. Specifically, the image processing task is allocated to multiple processing platforms; hence, given the computing hardware resources of the mobile terminal, the algorithm processing is further accelerated by considering actual hardware loads, thereby improving a response speed and experience of the mobile terminal, and enhancing adaptability of advanced complex algorithms.

In order to make the above purposes, features and beneficial effects of the present disclosure more obvious and easy to be understood, the embodiments of the present disclosure are described in detail below in combination with the drawings.

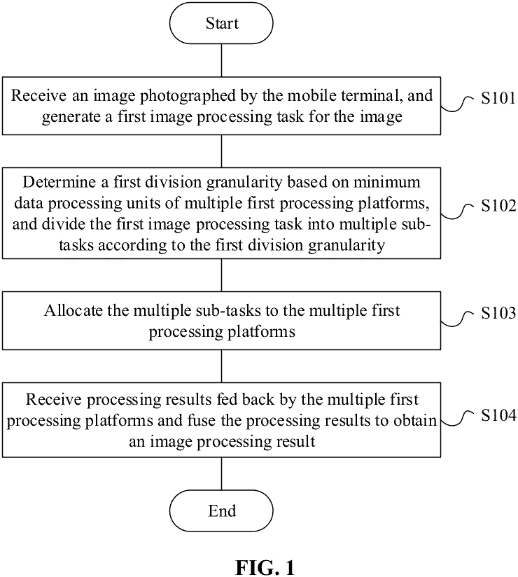

FIG. 1 is a flowchart of a method for processing image for a mobile terminal according to an embodiment of the present disclosure.

The mobile terminal in the solution according to this embodiment may be provided with multiple processing platforms, including but not limited to a CPU processing platform, a GPU processing platform, and a DSP processing platform.

With the solution according to this embodiment, computing resources of processing platforms of the mobile terminal are made full use of. Through multi-hardware heterogeneous combined-acceleration, time consumption of algorithm processing is further reduced, improving the image processing speed of the mobile terminal, and enhancing user experience.

The solutions according to the embodiments are applicable to low-end mobile terminals and enable the low-end mobile terminals to run an advanced and complex algorithm to process an image through heterogeneous combined-acceleration.

In an implementation, the method for processing image for a mobile terminal including the following S101 to S104 may be performed by a chip with image processing function in user equipment, or performed by a baseband chip, a GPU chip, a CPU chip, and the like in the user equipment. For example, the user equipment may include the mobile terminal described above.

Referring to FIG. 1, the method for processing image for a mobile terminal according to this embodiment includes the following steps.

In S101, an image photographed by the mobile terminal is received, and a first image processing task for the image is generated.

In S102, a first division granularity is determined based on minimum data processing units of multiple first processing platforms, and the first image processing task is divided into multiple sub-tasks according to the first division granularity.

In S103, the multiple sub-tasks are allocated to the multiple first processing platforms.

In S104, processing results fed back by the multiple first processing platforms are received, and the processing results are fused to obtain an image processing result.

In an implementation, the image may be acquired by an image sensor configured in the mobile terminal.

Further, the first image processing task may be configured to apply specific algorithm processing on the image, for example, applying white balance, black level correction, automatic exposure, and other algorithm processing.

Image computing tasks generally have pixel similarity and are suitable for parallel computing. Therefore, for purpose of fused-computing in the solution according to this embodiment, the computing task is divided into multiple sub-tasks first.

In an implementation, an appropriate granularity may be selected according to actual conditions of the algorithms. S102 may include determining the first division granularity based on a least common multiple of respective minimum data processing units of the multiple first processing platforms.

For example, an integer multiple of the least common multiple may serve as the first division granularity.

Further, S102 may further include segmenting the image according to the first division granularity to obtain multiple image regions, where the multiple image regions are in one-to-one correspondence with the multiple sub-tasks.

For example, the image may be segmented by rows or by blocks. For example, in a case of segmenting by rows, the image may be segmented by image behavior granularity of 8 rows. In the case of segmenting by blocks, the image may be segmented by blocks of 32*32 pixels.

Further, in segmentation of the image according to the first division granularity, adjacent image regions do not overlap with each other.

In a variant example, image regions corresponding to at least some of the multiple sub-tasks overlap with each other. That is, in segmentation of the image according to the first division granularity, there may be overlap among adjacent image regions.

Correspondingly, in fusing the image processing results of the first processing platforms in S104, special processing may be performed on image processing results of different first processing platforms with respect to the overlapped regions to ensure accuracy of the fusion. For example, memory consistency processing is performed.

In an implementation, the multiple first processing platforms to which the first image processing task is required to be allocated may be selected by the developer. Software development and algorithm performance simulation are performed for the selected processing platforms to obtain performance data.

For example, the performance data includes computing power of the processing platforms.

In an implementation, S103 may include allocating the multiple sub-tasks to the multiple first processing platforms based on computing powers and real-time loads of respective multiple first processing platforms.

Specifically, in allocating the tasks, the sub-tasks are appropriately allocated based on the algorithm performance and the loads of respective first processing platforms, where the algorithm performance and loads are obtained in previous simulation. Time balance is mainly considered to shorten waiting time during synchronization as much as possible.

Accordingly, an amount of sub-tasks allocated to at least some of the multiple first processing platforms is different from an amount of sub-tasks allocated to others of the multiple first processing platforms.

A case in which the multiple first processing platforms include CPU processing platform(s) and DSP processing platform(s) is taken as an example. Assuming determining through simulation that the computing power of the CPU processing platform is 1.0, computing power of the DSP processing platform is 2.0, and current loads of the two first processing platforms are basically the same, in performing S103, one-third of the first image processing task may be allocated to the CPU processing platform(s) and two-thirds of the first image processing task may be allocated to the DSP processing platform(s). Tasks are allocated in such a way that the CPU processing platform(s) and the DSP processing platform(s) almost complete tasks at the same time.

In an implementation, the first processing platforms perform accelerated processing for the allocated sub-tasks according to respective algorithms running on the first processing platforms, and the algorithms running on the first processing platforms are the same as each other.

For example, each of the GPU processing platform and the DSP processing platform accelerates black level correction algorithm processing on the allocated image regions.

In a variant example, the algorithms running on the first processing platforms are executable in parallel.

Assuming that noise reduction processing is to be performed only on a first image region of the image acquired in S101, and high dynamic processing is to be performed only on a second image region of the image acquired in S101, then in S103, the CPU processing platform is allocated for accelerating noise reduction algorithm processing on the first image region, and both the GPU processing platform and the DSP processing platform are allocated for accelerating high dynamic processing on the second image region.

In an implementation, in S104, in fusing the sub-tasks, image processing results of the sub-tasks may be fused according to an adjacent relationship between the image regions corresponding to the sub-tasks.

In an embodiment, after S104, the method for processing image further includes: generating a second image processing task based on the image processing result; determining a second division granularity based on minimum data processing units of multiple second processing platforms, and dividing the second image processing task into multiple sub-tasks according to the second division granularity; allocating the multiple sub-tasks to the multiple second processing platforms; and receiving processing results fed back by the multiple second processing platforms and obtaining a processed image processing result by fusing the processing results.

Thus, when processing the image acquired by the mobile terminal, first division is performed based on algorithm used for processing the image. The first image processing task is generated for algorithm required to be executed first. Division granularity is determined based on the first processing platforms on which the algorithm required to be executed first runs, and the image processing task is divided according to the division granularity. Further, after the first processing platforms finish the allocated image processing, processing results of the first processing platforms are fused. Then division granularity is re-determined based on the second processing platforms on which algorithm required to be executed latter runs, and tasks are allocated to the second processing platforms to obtain a final image processing result.

Further, the algorithm running on the second processing platforms and the algorithm running on the first processing platforms are executed in series.

For example, assuming that the image acquired in S101 is required to be subjected to noise reduction processing first and then subjected to automatic exposure processing, then in S103, each of the CPU processing platform and the DSP processing platform is allocated for accelerating the noise reduction algorithm processing on a part of the image. After noise reduction processing results are fused, each of the GPU processing platform and the DSP processing platform is allocated for accelerating the automatic exposure processing on a part of the image.

For noise reduction processing, image processing tasks are allocated based on computing power and real-time loads of the CPU processing platform and the DSP processing platform. For automatic exposure processing, image processing tasks are allocated based on computing power and real-time loads of the GPU processing platform and the DSP processing platform.

That is, the first division granularity is different from the second division granularity. In other words, the division granularity is adjustable during the image processing.

As described above, by means of the solution according to the embodiments, multi-hardware heterogeneous combined-acceleration can be realized by combining resources and algorithm acceleration schemes of the mobile terminal to further reduce time consumption of algorithm processing. Specifically, the image processing task is allocated to multiple processing platforms; hence, given the computing hardware resources of the mobile terminal, the algorithm processing is further accelerated by considering actual hardware loads, thereby improving a response speed and experience of the mobile terminal, and enhancing adaptability of advanced complex algorithms.

Furthermore, the solution according to this embodiment has adaptability in dividing the task into sub-tasks. A proportion of amounts of the sub-tasks respectively performed by different processing platforms is not limited, and the sub-tasks are allocated based on actual loads and algorithm performances of the processing platforms to achieve an optimal acceleration effect.

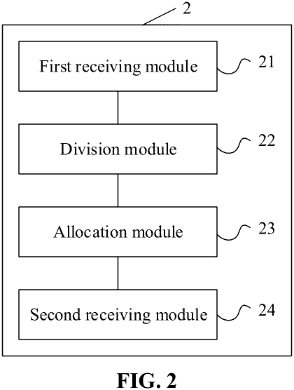

FIG. 2 is a schematic structural diagram of an apparatus for processing image for a mobile terminal according to an embodiment of the present disclosure. Those skilled in the art can understand that the apparatus for processing image 2 for a mobile terminal according to this embodiment may be configured to perform the method in the technical solution according to the embodiment shown in FIG. 1.

Referring to FIG. 2, the apparatus for processing image 2 for a mobile terminal according to this embodiment may include a first receiving module 21, a division module 22, an allocation module 23, and a second receiving module 24. The first receiving module 21 is configured to receive an image photographed by the mobile terminal and generate a first image processing task for the image. The division module 22 is configured to determine a first division granularity based on minimum data processing units of multiple first processing platforms and divide the first image processing task into multiple sub-tasks according to the first division granularity. The allocation module 23 is configured to allocate the multiple sub-tasks to the multiple first processing platforms. The second receiving module 24 is configured to receive processing results fed back by the multiple first processing platforms and obtain an image processing result by fusing the processing results.

For more information about principles and operations of the apparatus for processing image 2 for the mobile terminal, one may refer to related description for FIG. 1, which is not repeated here.

In an implementation, the apparatus for processing image 2 for a mobile terminal may correspond to a chip with an image processing function in the mobile terminal or correspond to a chip with a data processing function, such as a System-On-a-Chip (SOC), a GPU chip, and a CPU chip. Alternatively, the apparatus for processing image 2 corresponds to a chip module including a chip with an image processing function in the mobile terminal, a chip module including a chip with a data processing function, or the mobile terminal.

In implementation, the modules/units included in the various apparatuses and products described in the above embodiments may be software modules/units or hardware modules/units, or partially be software modules/units and partially be hardware modules/units.

For example, for each device or product applied to or integrated into a chip, each module/unit included therein may be realized through circuits or other hardware; or at least some of the modules/units may be realized through software programs running on a processor integrated inside the chip, and the remaining (if any) modules/units may be realized through circuits or other hardware. For each device or product applied to or integrated into a chip module, each module/unit included therein may be realized through circuits or other hardware. Different modules/units may be disposed in a same component (such as a chip, a circuit module, or the like) or different components of the chip module; or at least some of the modules/units may be realized through software programs running on a processor integrated inside the chip module, and the remaining (if any) modules/units may be realized through circuits or other hardware. For each device or product applied to or integrated in a terminal, each module/unit may be realized through circuits or other hardware. Different modules/units may be disposed in a same component (such as a chip, a circuit module, or the like) or different components in the terminal; or at least some of the modules/units may be realized through software programs running on a processor integrated inside the terminal, and the remaining (if any) modules/units may be realized through circuits or other hardware.

A storage medium is further provided according to an embodiment of the present disclosure. The storage medium stores a computer program that, when being executed by a processor, implements the method as described in FIG. 1. The storage medium may include a computer readable storage medium such as a non-volatile memory or a non-transient memory. The storage medium may include an ROM, an RAM, a disk, an optical disc, or the like.

A terminal device is further provided according to an embodiment of the present disclosure. The terminal device includes a memory and a processor. The memory stores a computer program executable by a processor. The computer program, when being executed by the processor, implements the method as described in FIG. 1. For example, the terminal device may be a mobile terminal such as a mobile phone and an IPAD. The mobile terminal may be provided with an image sensor. Alternatively, the terminal may include the apparatus for processing image 2 for a mobile terminal shown in FIG. 2.

Although the present disclosure is disclosed as above, the present disclosure is not limited to this. Those skilled in the art can make various changes and modifications without departing from the spirit and scope of the present disclosure. Therefore, the scope of the present disclosure is defined by the claims.

1. A method for processing image for a mobile terminal, comprising:
receiving an image photographed by the mobile terminal;
generating a first image processing task for the image;
determining a first division granularity based on minimum data processing units of a plurality of first processing platforms;
dividing the first image processing task into a plurality of sub-tasks according to the first division granularity;
allocating the plurality of sub-tasks to the plurality of first processing platforms;
receiving processing results fed back by the plurality of first processing platforms; and
obtaining an image processing result by fusing the processing results.

2. The method according to claim 1, wherein said allocating the plurality of sub-tasks to the plurality of first processing platforms comprises:
allocating the plurality of sub-tasks to the plurality of first processing platforms based on respective computing powers and real-time loads of the plurality of first processing platforms.

3. The method according to claim 2, wherein an amount of sub-tasks allocated to at least some of the plurality of first processing platforms is different from an amount of sub-tasks allocated to others of the plurality of first processing platforms.

4. The method according to claim 1, wherein the plurality of first processing platforms perform accelerated processing for the allocated sub-tasks according to respective algorithms running on the first processing platforms, wherein the algorithms running on the plurality of first processing platforms are the same as each other, or the algorithms running on the plurality of first processing platforms are executable in parallel.

5. The method according to claim 1, wherein said determining a first division granularity based on minimum data processing units of a plurality of first processing platforms comprises: determining the first division granularity based on a least common multiple of respective minimum data processing units of the plurality of first processing platforms.

6. The method according to claim 1, wherein said dividing the first image processing task into a plurality of sub-tasks according to the first division granularity comprises: segmenting the image according to the first division granularity to obtain a plurality of image regions, wherein the plurality of image regions are in one-to-one correspondence with the plurality of sub-tasks.

7. The method according to claim 6, wherein image regions corresponding to at least some of the plurality of sub-tasks overlap with each other in segmentation.

8. The method according to claim 1, further comprising:
generating a second image processing task based on the image processing result;
determining a second division granularity based on minimum data processing units of a plurality of second processing platforms, and dividing the second image processing task into a plurality of second sub-tasks according to the second division granularity;
allocating the plurality of second sub-tasks to the plurality of second processing platforms; and receiving second processing results fed back by the plurality of second processing platforms and obtaining a processed image processing result by fusing the second processing results.

9. The method according to claim 8, wherein an algorithm running on the second processing platforms and the algorithm running on the first processing platforms are executed in series.

10. The method according to claim 8, wherein the first division granularity is different from the second division granularity.

11. (canceled)

12. (canceled)

13. A non-transitory storage medium having a computer program stored thereon, wherein the computer program, when being executed by a processor, causes the processor to:
receive an image photographed by the mobile terminal; generate a first image processing task for the image; determine a first division granularity based on minimum data processing units of a plurality of first processing platforms; divide the first image processing task into a plurality of sub-tasks according to the first division granularity;
allocate the plurality of sub-tasks to the plurality of first processing platforms; receive processing results fed back by the plurality of first processing platforms; and obtain an image processing result by fusing the processing results.

14. A terminal device, comprising a processor and a memory storing a computer program executable by the processor, wherein the processor is configured to:
receive an image photographed by the mobile terminal;
generate a first image processing task for the image; determine a first division granularity based on minimum data processing units of a plurality of first processing platforms;
divide the first image processing task into a plurality of sub-tasks according to the first division granularity; allocate the plurality of sub-tasks to the plurality of first processing platforms; receive processing results fed back by the plurality of first processing platforms; and obtain an image processing result by fusing the processing results.

15. The terminal device according to claim 14, wherein the processor is further configured to: allocate the plurality of sub-tasks to the plurality of first processing platforms based on respective computing powers and real-time loads of the plurality of first processing platforms.

16. The terminal device according to claim 14, wherein the processor is further configured to:
determine the first division granularity based on a least common multiple of respective minimum data processing units of the plurality of first processing platforms.

17. The terminal device according to claim 14, wherein the processor is further configured to:
segment the image according to the first division granularity to obtain a plurality of image regions, wherein the plurality of image regions are in one-to-one correspondence with the plurality of sub-tasks.

18. The terminal device according to claim 17, wherein image regions corresponding to at least some of the plurality of sub-tasks overlap with each other in segmentation.

19. The terminal device according to claim 14, wherein the processor is further configured to: generate a second image processing task based on the image processing result; determine a second division granularity based on minimum data processing units of a plurality of second processing platforms, and dividing the second image processing task into a plurality of second sub-tasks according to the second division granularity;
allocate the plurality of second sub-tasks to the plurality of second processing platforms; and receive second processing results fed back by the plurality of second processing platforms and obtain a processed image processing result by fusing the second processing results.

20. The terminal device according to claim 19, wherein an algorithm running on the second processing platforms and the algorithm running on the first processing platforms are executed in series.

21. The terminal device according to claim 14, wherein the first division granularity is different from the second division granularity.

22. The terminal device according to claim 14, wherein each of the first processing platforms and the second processing platforms is at least selected from a CPU processing platform, a GPU processing platform, and a DSP processing platform.
